(19) United States
(12) Patent Application Publication
(10) Pub. No.: US 2015/0033139 A1
(43) Pub. Date: Jan. 29, 2015

(54) COMMUNICATION WITH ON-CALLS AND MACHINES USING MULTIPLE MODALITIES THROUGH SINGLE HISTORICAL TRACKING

(71) Applicant: Microsoft Corporation, Redmond, WA (US)

(72) Inventors: Gregory Thiel, Kirkland, WA (US); Clifford Dibble, Bellevue, WA (US)

(73) Assignee: Microsoft Corporation, Redmond, WA (US)

(21) Appl. No.: 13/948,849

(22) Filed: Jul. 23, 2013

(51) Int. Cl. G06F 3/0484

(52) U.S. Cl. CPC G06F 3/0484
USPC 715/740

(57) ABSTRACT

A unified communication (UC) application integrates support actions with client communications. In response to receiving an escalation of an issue from a support technician, the UC client application initiates a communication between a responder and a target device associated with the issue. The communication is limited based on privileges of an account used to initiate the communication. A user interface component associated with the communication is provided to enable interactions with the target device. The user interface component is selected based on an instant message, an audio, a video, a remote control session, and similar modality used to communicate with the target device and additional responders. Communications associated with the issue are integrated into a communication session. A history of the session is also recorded and formatted into a timeline list. The history is provided in a subsequent issue having common attributes with the issue.

### BACKGROUND

Modern communication systems have a large number of capabilities including integration of various communication modalities with different services. For example, instant messaging, voice/video communications, data/application sharing, white-boarding, and other forms of communication may be combined with presence and availability information of subscribers. Such systems may provide subscribers with the enhanced capabilities such as providing instructions to callers for various status categories, alternate contacts, calendar information, and comparable features. Furthermore, collaboration systems enabling users to share and collaborate in creating and modifying various types of documents and content may be integrated with multimodal communication systems providing different kinds of communication and collaboration capabilities. Such integrated systems are sometimes referred to as Unified Communication (UC) systems.

Modern UC implementations provide significant advantages to support environments. Access to multiple modalities of communication through a single platform enable support engineers to save resources and time in accessing customers and troubleshooting issues. However, current UC implementations hinder progress in support when scaling to plurality of responders engaging an issue. When faced with multiple responders, the number of displayed communication modalities prevent engineers from effectively engaging the issue. In addition, lack of integration with issue management systems prevent engineers from effective consolidation of information associated with the issue and communications associated with the issue.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to integrating support actions with client communications. A unified communication (UC) client application may receive an escalation of a support issue from a support technician. The escalation may be a communication from the support technician modifying a status of an existing issue or creating a new issue and escalating its status. Next, the issue may be associated with a first responder. The first responder may be a member of support team with skills matching attributes associated with the issue. In addition, a target device may be identified to be associated with the issue. The target device may be identified through the application by the first responder or through an automated scheme. The first responder may complete external diagnostics to identify the target device. Alternatively, multiple target devices may be identified to be associated with the issue by the first responder or through an automated scheme. The automated scheme may associate target device(s) with the issue based on common attributes. Additional issues may also be aggregated to the issue based on common attributes.

The application may initiate a first communication with a target device associated with the issue. A user interface (UI) component associated with the first communication may be provided to enable interactions with the target device. The UI component may include an instant messaging (IM) session enabling interaction with the target device. Alternatively, the UI component may include a remote control session (RCS) providing a terminal to the target device within the UC client application.

A second responder may also be determined to be associated with the issue or the first responder. The second responder may be determined to be a team member of the first responder. The second responder may also be determined to have skills associated with the attributes of the issue. The UI component may be provided to the second responder to enable additional interactions with the target device through another instance of the UC client application associated with the second responder. In addition, a second communication associated with the issue may be detected between the second responder and the first responder or the target device. The first communication and the second communication may be integrated into a communication session associated with the issue. The first and second communications may include an audio call, a video call, an instant messaging, a remote control session, and similar communications.

In addition, the UC client application may record a history of the session formatted into a timeline list. Interactions between responder, target device, and the support technician during the session may be time stamped, sorted based on start time and duration, and recorded. Furthermore, the history may be provided in a subsequent issue having common attributes to the recorded issue. The history may be presented with actionable items to duplicate interactions recorded in the issue.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example enhanced communications system such as a unified communication (UC) system, where embodiments may be implemented for integrating support actions with client communications;

FIG. 2 illustrates an example user interface (UI) of a UC client application providing interaction controls with a target device, according to embodiments;

FIG. 3 illustrates another example UI of a UC client application providing a remote control session (RCS) with the target device, according to embodiments;

FIG. 4 illustrates yet another example UI of a UC client application providing an issue history, according to embodiments;

FIG. 5 is a simplified networked environment, where a system according to embodiments may be implemented;

FIG. 6 is a block diagram of an example computing operating environment, where embodiments may be implemented; and

FIG. 7 illustrates a logic flow diagram for a process of integrating support actions with client communications according to embodiments.

### DETAILED DESCRIPTION

As briefly described above, support actions may be integrated with client communications. A unified communications (UC) client application may initiate support communications between a first responder, a second responder, and a target device associated with an issue, in response to receiving an escalation of the issue. The UC client application may provide a user interface (UI) component associated with the first and second communications to enable interactions between the first responder, the second responder, and the target device. The communications may be integrated into a communication session. And, a history of the session may be recorded, formatted into a timeline list, and provided in a subsequent issue having common attributes with the recorded issue.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components for integrating support actions with client communications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

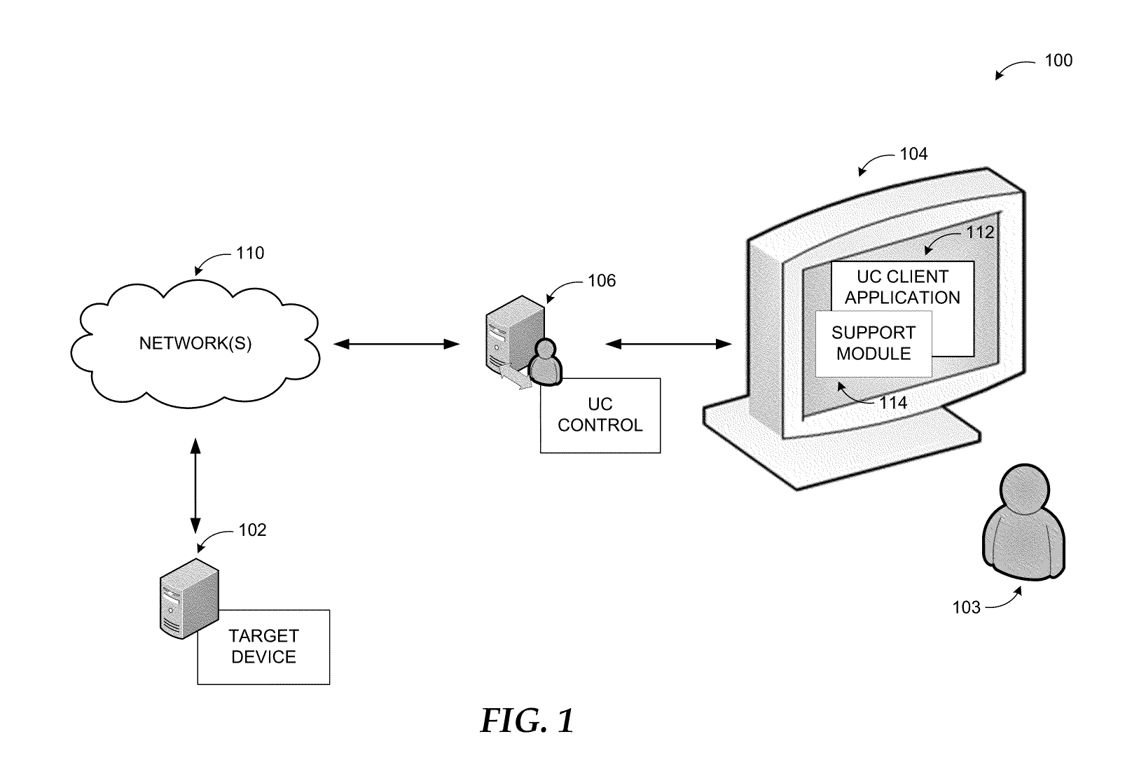

FIG. 1 includes diagram 100 illustrating an example enhanced communications system such as a UC system, where embodiments may be implemented for integrating support with client communications. A unified communication (UC) system is an example of modern communication systems with a wide range of capabilities and services that can be provided to subscribers. A unified communication system is a real-time communications system facilitating email exchange, instant messaging, presence, audio-video conferencing, web conferencing, and similar functionalities.

In a unified communication (UC) system such as the one shown in diagram 100, users may communicate via a variety of end devices including a tablet, a smart phone, a laptop computer, and a desktop computer 104, which are client devices of the UC system. Each client device may be capable of executing one or more communication applications such as UC client application 112 for voice communication, video communication, instant messaging, application sharing, data sharing, and similar ones. Client devices may include any type of smart phone, cellular phone, any computing device executing a communication application, a smart automobile console, and advanced phone devices with additional functionality.

Client devices, including the desktop computer 104, may execute the UC client application 112 to facilitate communications between users. A user such as a responder 103 may interact with the UC client application to manage a support issue. The responder may be a member of a technical support team determined to have skills associated with the issue. The skills may be determined to match a predetermined criteria associated with managing the issue. The UC client application 112 may use a support module 114 to communicate with a target device 102 associated with the support session. The support module 114 may be integrated with the UC client application 112. Alternatively the support module 114 may also be an external application programming interface (API) package providing extended functionality to the UC client application 112.

In addition, the target device 102 may be identified to be associated with the issue. The target device 102 may be identified through the UC client application 112 by the responder 103 or through an automated scheme. The responder 103 may complete external diagnostics to identify the target device 102. Alternatively, multiple target devices may be identified to be associated with the issue by the responder 103 or through an automated scheme. The automated scheme may associate target device(s) with the issue based on common attributes. Additional issues may also be aggregated to the issue based on common attributes.

The UC client application 112 may manage multiple communications between responders associated with the issue. A responder 103 may be automatically determined by matching skills associated with the responder 103 to attributes of the issue. Skills and potential responders may be retrieved from services associated with a human resources data store, personal data store or similar ones. A communication may automatically be established with the target device 102 based on the attributes of the issue and the skills or preferences of the responder 103. In an example scenario, a command line communication interface may be established with a responder 103 and the target device 102 to execute commands associated with the issue at the target device 102.

The UC client application 112 may integrate input capability of the desktop computer 104 and enable interactivity such as a keyboard input and a mouse input based on the available input capabilities of the desktop computer 104. Input type provided by client devices, such as the desktop computer 104, are not limited to mouse and keyboard based input but may include touch, audio, visual, gesture, pen, and similar ones.

The UC system shown in diagram 100 may include a number of servers performing different tasks. For example, UC control server 106 may reside in a perimeter of a network(s) 110 and enable connectivity through the network(s) 110 with external users or target device 102. The desktop computer 104 may communicate with the target device 102 through the UC client application 112 to manage a support session associated with the target device 102. The UC client application 112 may initiate the support session in response to an escalation of an issue associated with the target device 102 such as a malfunction or a degraded performance. The escalation may be received by the UC client application 112 through a communication from a support technician associated with the issue. The support technician may be a person who initially investigated the issue or managed the issue prior to the escalation.

UC control server 106 may also act as a Session Initiation Protocol (SIP) user agent. In a UC system, users may have one or more identities (such as a call identifier), which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method. SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer. Various components of the system may communicate using protocols like SIP, hypertext transport protocol (HTTP), and comparable ones.

While the example system in FIG. 1 has been described with specific components UC control server 106, desktop computer 104 executing the UC client application 112, and target device 102 communicating with the UC client application 112, embodiments are not limited to these components or system configurations and can be implemented with other system configuration employing fewer or additional components. In an alternate scenario, the UC control server 106 may execute the support module 114 and manage and monitor the support session. In another alternate scenario, the client devices, such as desktop computer 104, may be enabled to access the target device 102 directly and establish a support session. Furthermore, embodiments are not limited to UC systems. The approaches discussed here may be applied to any data exchange in a networked communication environment using the principles described herein.

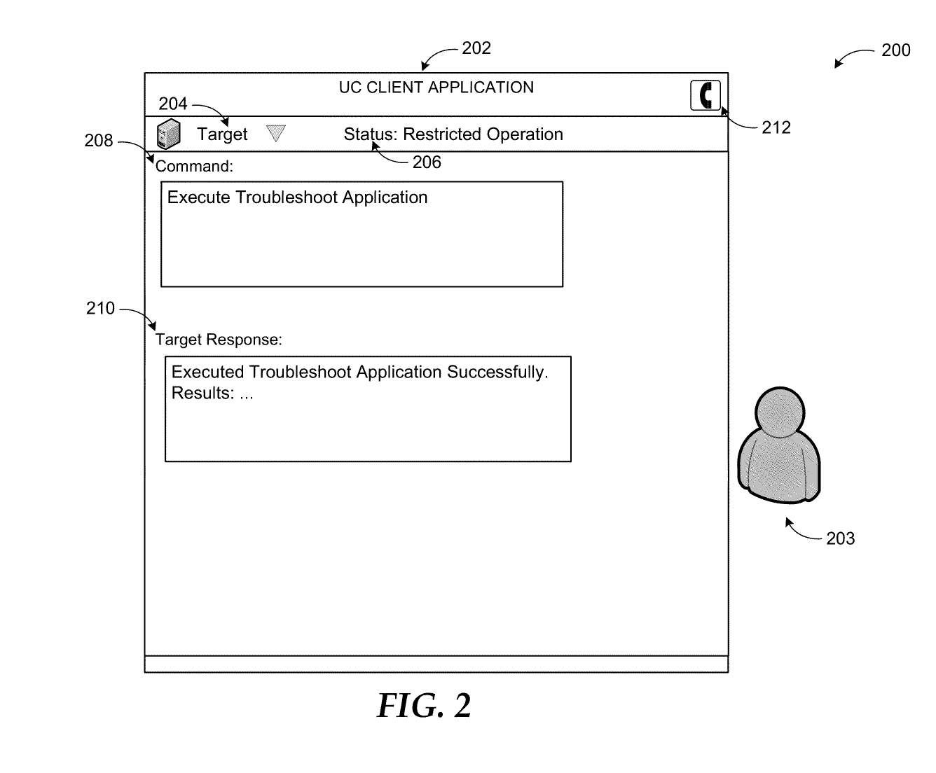

FIG. 2 illustrates an example user interface (UI) of a UC client application providing interaction controls with a target device, according to embodiments. Diagram 200 illustrates an example UC client application 202 providing instant messaging (IM) based communication between a responder 203 and the target device to execute operations on the target device during a support session.

The UC client application 202 may provide communication controls 204 to manage the support communication established with the target device. The communication controls 204 may be used by the responder 203 to communicate with the target device and execute operations associated with the issue. The communication controls 204 may include a graphic to represent the target device. The graphic may be presented in a variety of colors associated with a status of the target device. In an example scenario, a green graphic may represent a target device in “a working” status, a yellow graphic may represent a target device in “a restricted operation” status, and a red graphic may represent a target device in “a broken” status. The communication controls 204 may also display an identifier associated with the target device. In addition, the communication controls 204 may provide a menu control to display additional operations associated with the support session. In an example scenario, the UC client application 202 may provide modality controls such as IM, command line engagement, and similar ones through the menu control within the communication controls 204. Furthermore, the status 206 of the target device may also be displayed through a summary string by the UC client application 202.

In addition, the UC client application 202 may determine additional target devices associated with the issue based on the attributes of the issue and associations with the target device. The additional target devices may be presented through communication controls 204 to enable the responder 203 to interact with the additional target devices in communications associated with the issue. An example may include a command line communication to execute operations associated with commands associated with the issue.

The UC client application may also provide communication control 212 to initiate an audio or a video call with a second responder or a support technician associated with the issue. The support technician may be a person who initially investigated the issue or managed the issue prior to the escalation. In response to activation of the communication control 212, the UC client application may establish a call with the second responder associated with the issue. The call may be an audio and/or video call and provide support for other communication modalities including instant messaging.

The responder 203 may input a command to a command prompt 208 for transmission to the target device during the support session. The command may be transmitted to execute an associated operation at the target device. The UC client application 202 may present the command prompt to the responder 203 through an IM session. In addition, the UC client application 202 may receive a response from the target device describing a result of the executed operation which may be displayed in a response prompt 210.

The UC client application 202 may also suggest potential commands while the responder 203 is typing the command into the command prompt 208 for transmission to the target device. The potential commands may be retrieved from a historical data store managing prior commands associated with support sessions. The UC client application 202 may analyze the typed command (or portions) to match potential commands from the historical data store in order to suggest them to the responder 203. The UC client application 202 may insert a responder selected potential command into the command prompt 208 and transmit the potential command to the target device. In addition, command contents may be extracted from attributes of the issue including a type of the issue, information associated with the target device, and similar ones.

In addition, a subsequent command may be transmitted to the target device for execution of an associated operation in response to the responder 203 typing the subsequent command into the other command prompt following the response prompt 210. Response to the subsequent command may be displayed following the subsequent command within another response prompt following the other command prompt.

Transmission of commands to the target device and display of responses to the responder 203 are not limited to the IM modality of the UC client application 202. Other modalities such as email exchanges, gesture based input, and similar ones may be used to select and transmit commands to the target device. Responses may also be displayed in non-text form through visualizations and graphics associated with a status of the target device.

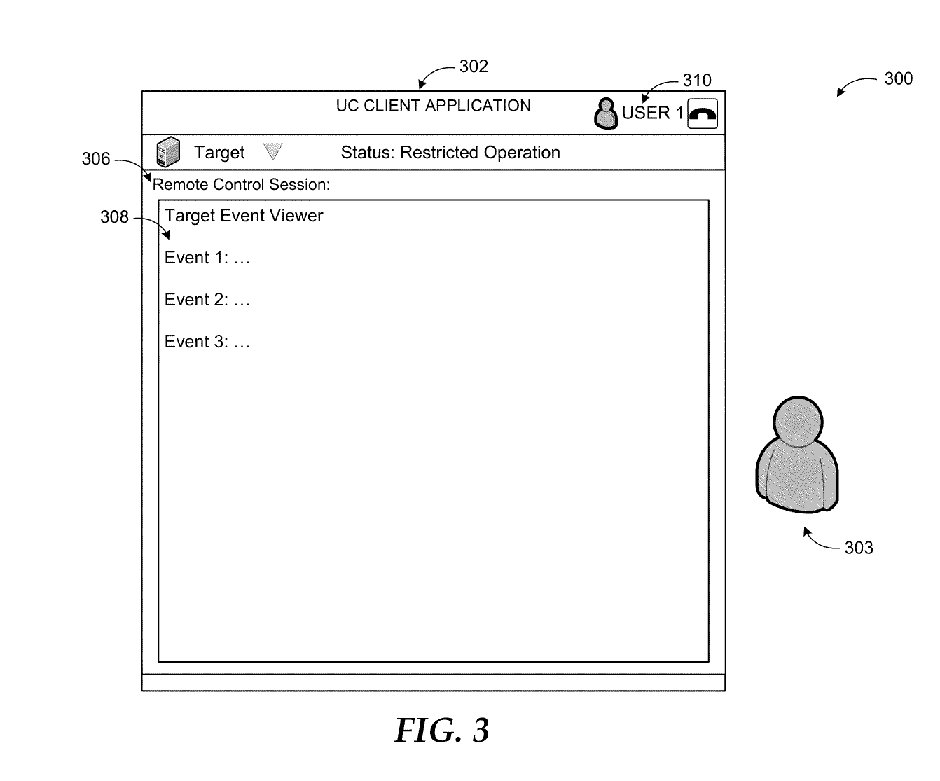

FIG. 3 illustrates another example UI of a UC client application providing a remote control session (RCS) with the target device, according to embodiments.

As shown in diagram 300, a responder 303 is enabled to establish a remote control session (RCS) with the target device. The RCS may mirror any UI component associated with an application executing in the target device. Alternatively, the RCS may duplicate a desktop UI of the target device. The responder 303 may be provided full interactivity with the target device during the support session. Alternatively, control provided to the responder 303 during RCS may be limited based on privileges associated with an account used to interact with the target device. The account may be that of the support technician escalating the issue or a user associated with the issue. When using the support technician's or the user's account, the UC client application 302 may retrieve credentials associated with the technician or the user and transmit them to the target device to gain access to the target device. The credentials may be retrieved from user account management servers or services available to the UC client application 302.

In an alternative scenario, the account may include a system established support account providing access to the applications, system, and resources of the target device. Access using the support account may shield privileged information from the responder 303 of the UC client application 302. In another scenario, the responder 303 establishing the RCS may access the target device using his/her credentials. The level of access will be limited based on available privileges to the responder 303 at the target device. The credentials of the responder 303, the support technician, or the support account may be selected and transmitted to the target device to initiate the RCS using the account.

The UC client application may also display communication controls 310 associated with an established call with a support technician escalating the issue or another responder associated with the issue. The UC client application may display the RCS 306 which may include an event viewer application UI 308 showing events associated with applications of the target device. Available applications through the RCS 306 are not limited to event viewer application UI 308. The UC client application 302 may access UI of any application available at the target device based on available privileges to the account used to initiate the RCS. The account used to initiate the RCS may include of the user account, the support technician account, and a support account.

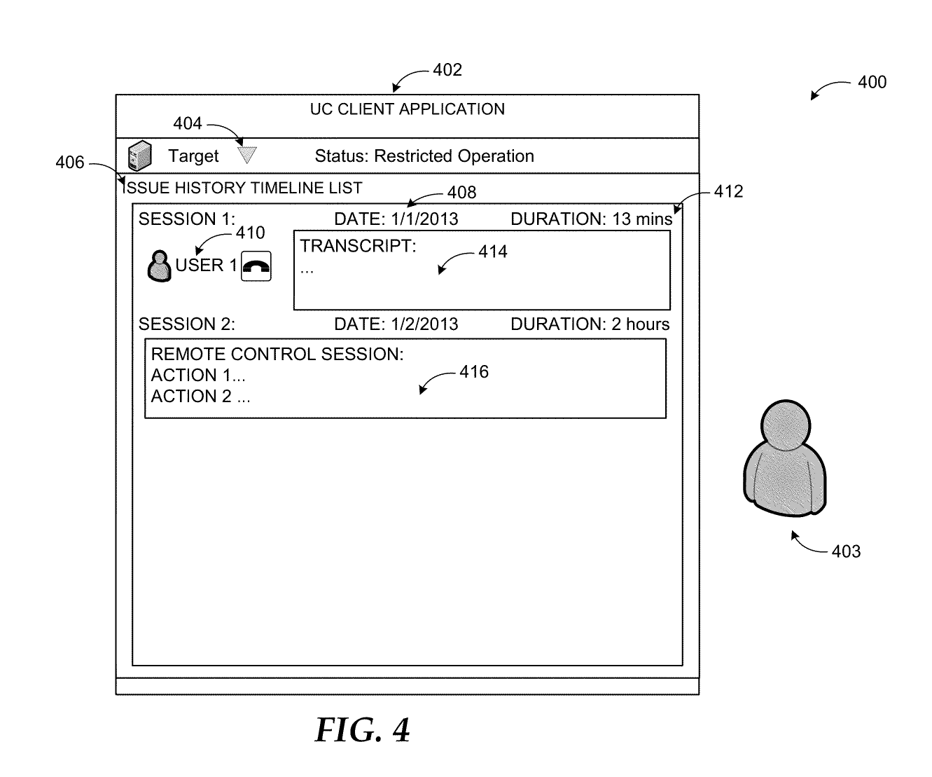

FIG. 4 illustrates yet another example UI of a UC client application providing an issue history, according to embodiments.

As shown in diagram 400, UC client application 402 may record and display an issue history timeline list 406 in association with the issue. The interactions during the issue including the escalation by the support technician, commands executed at the target device, responses to the commands from the target device, status of the target device, RCS with the target device, communications between the responder 403 and other responders and similar ones may be recorded by the UC client application 402. The interactions may be stored in a history of the session within a data store associated with issues. The history may be indexed based on contextual information associated with the target device, the issue, the support technician, the responder 403, the interaction type, the interaction description and the interaction result.

The UC client application 402 may display the history in response to a selection of an issue history timeline list from communication controls 404. The history may include a recording of a call between the responder 403 and the support technician 410 and a transcript 414 of the call. Any communications between the responder 403 and other responder may also be recorded. The communications may include audio, video, text based, and similar ones. In addition, the history may be recorded and displayed in a timeline list sorted based on a start time 408 of the interaction and/or the duration 412 of the interaction. The history may also include a summary of the RCS interactions 416. The summary of the RCS interactions may include interactions by the UC client application 402 during the RCS. Furthermore, audio, video, text based modalities of communications associated with the issue may be recorded in the history and presented in the issue history timeline list 406. The recorded modalities may be synchronized to actions executed associated with the issue. While replaying an action associated with the issue to the responder 403, the UC client application 402 may forward to a point in the recorded communication associated with the action being presented.

The interactions displayed on issue history timeline list 406 may also include actionable items to re-execute operations associated with the interactions. Alternatively, operations associated with the interactions may be re-executed in another target device by selecting another target device from the communication controls 404 to diagnose and fix the other target device during another support session.

In some embodiments, the UC client application 402 may contact other devices and applications associated with the responder 403 to notify the responder 403 of an escalation of an issue initiated by the support technician. A health status of the issue may also be recorded in the history. The health status may notify subsequent responders about a resolution status of the issue and success status of the interactions recorded in the history. The health status may be associated with each interaction to capture changing health status of the target device during the interactions. In addition, data and controls available to manage applications at the target device may be limited based on privilege of an account used to access the target device.

In other embodiments, other responders may be determined to be associated with the issue and a selection list of responders associated with the issue may be presented to the responder 403. In response to a selection by the responder 403, the UC client application may initiate another communication between the responder 403 and the selected responder. The responder 403 may also be enabled to manually provide a contact to establish a communication with an additional responder in regards to the issue. The history may be transmitted to the additional responder to display in a device associated with the additional responder. And, the additional responder may be added to the communications between the support technician, the responders and the target device. Communication modalities between the responder 403, the additional responder(s), target devices, and the support technician may be determined automatically based on hardware capabilities (including but not exclusive to audio, video, and text based capabilities) of devices executing the UC client application 402 and similar applications.

In further embodiments, the timeline list of the history may be used to create a postmortem report of the issue. The postmortem report may be transmitted to a responder 403, the support technician, a third party, or another application.

The example scenarios and schemas in FIG. 2 through 4 are shown with specific components, data types, and configurations. Embodiments are not limited to systems according to these example configurations. Integrating support actions with client communications may be implemented in configurations employing fewer or additional components in applications and user interfaces. Furthermore, the example schema and components shown in FIG. 2 through 4 and their subcomponents may be implemented in a similar manner with other values using the principles described herein.

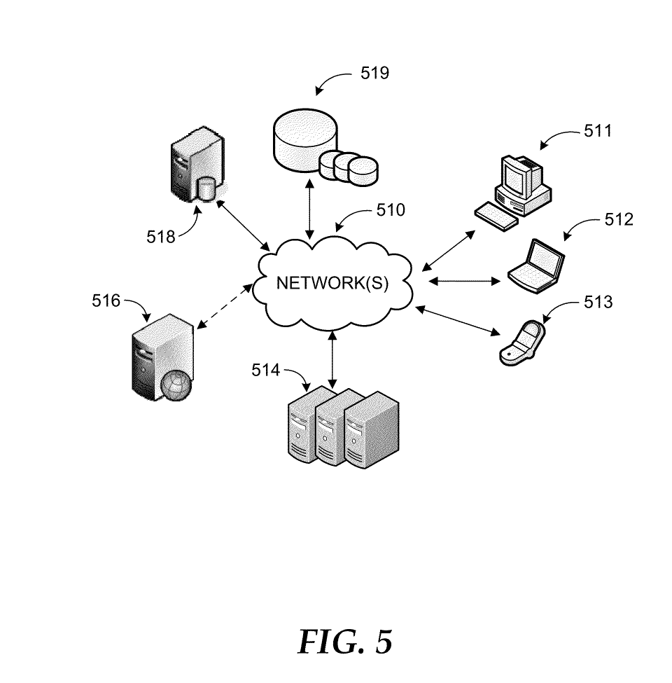

FIG. 5 is an example networked environment, where embodiments may be implemented. A system integrating support actions with client communications may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. A UC client application executed on client devices integrate support actions with client communications. The UC client application may initiate a support communication between a responder and a target device associated with an issue. A user interface associated with the communication may be displayed by the UC client application to enable interactions with the target device. In addition, the history of the session may be recorded into a timeline list and provided in a subsequent issue having common attributes. The application may store the history or additional data associated with the issue in data store(s) 519 directly or through database server 518 associated with the UC client application.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to integrate support actions with client communications. Furthermore, the networked environments discussed in FIG. 5 are for illustration purposes only. Embodiments are not limited to the example applications, modules, or processes.

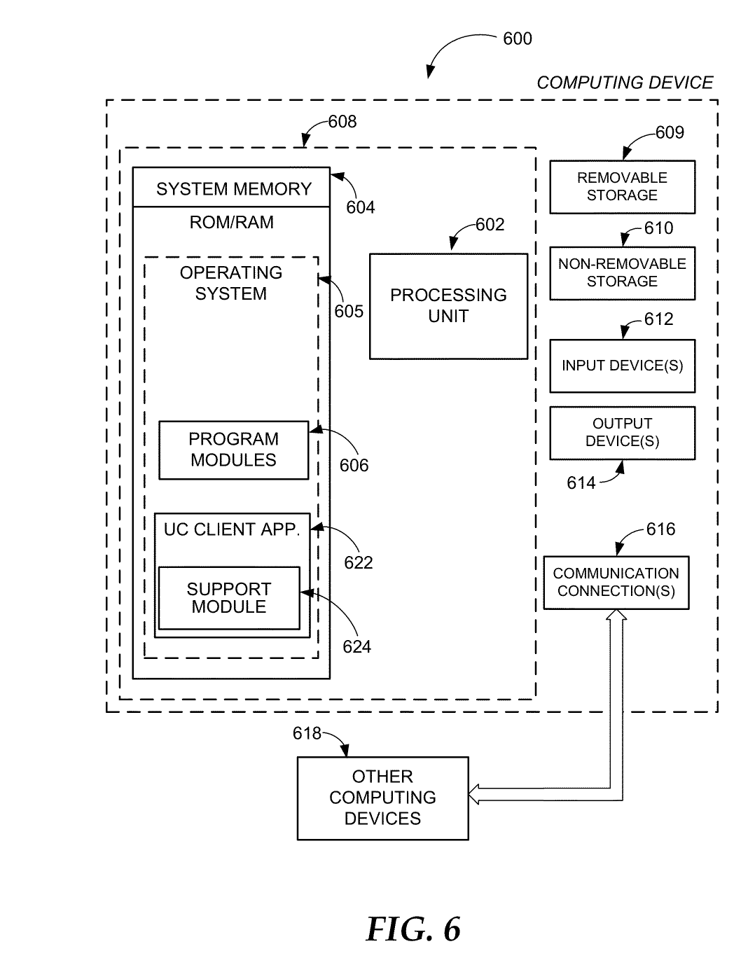

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing a UC client application according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, UC client application 622, and support module 624.

UC client application 622 may integrate support with client communications. The UC client application 622 may receive an escalation of an issue from a support technician. The UC client application 622 may initiate a communication between a responder and the target device through support module 624 and may display a UI component associated with the communication. The UC client application 622 may record a history of the communication into a timeline list and provide the history in a subsequent issue having common attributes. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

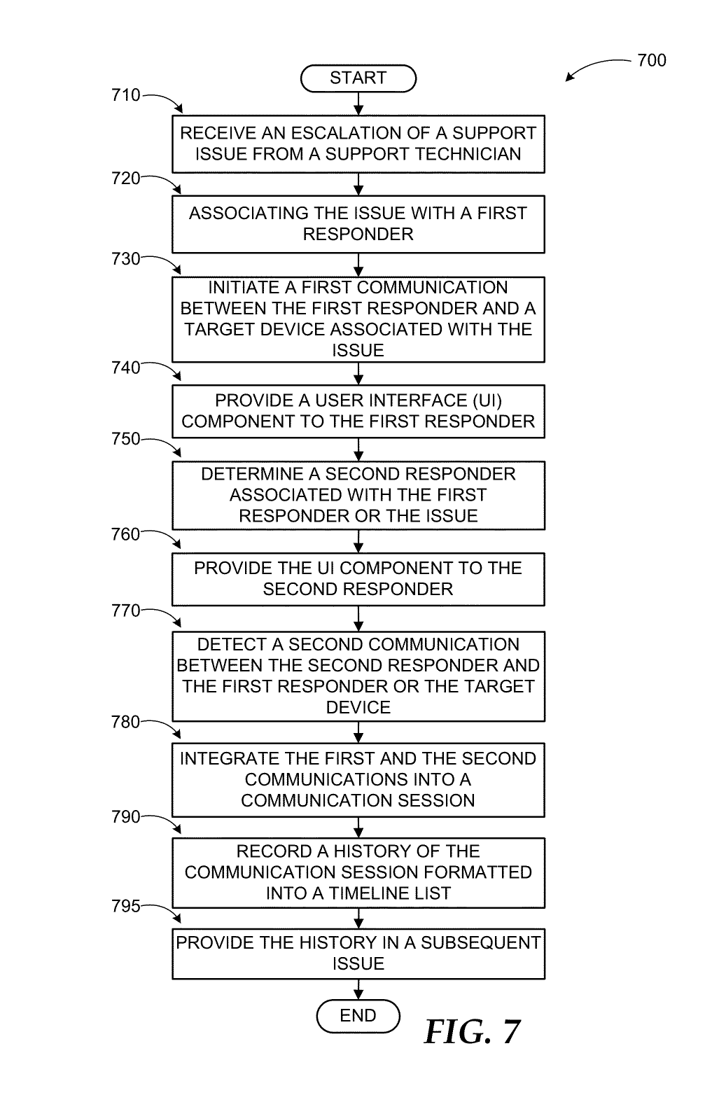

FIG. 7 illustrates a logic flow diagram for a process of integrating support actions with client communications according to embodiments. Process 700 may be implemented on a UC client application.

Process 700 begins with operation 710 receiving an escalation of a support issue from a support technician. The escalation may be received through a communication (i.e.: a call) from the support technician. The escalation may be associated with an issue based on contextual information associated with the communication including a description of the issue and an escalation status. At operation 720, the issue may be associated with a first responder. A target device may be identified to be associated with the issue through the UC client application by the first responder or through an automated scheme. The first responder may complete external diagnostics to identify the target device. Alternatively, multiple target devices may be identified to be associated with the issue by the first responder or through an automated scheme. The automated scheme may associate target device(s) with the issue based on common attributes. Additional issues may also be aggregated to the issue based on common attributes.

At operation 730, the UC client application may initiate a first communication between the first responder and a target device associated with the issue. Next, a UI component associated with the first communication may be provided to the first responder to enable interactions with the target device at operation 740. The UI component may display an IM session, an audio communication, a video communication, an RCS session, and similar ones.

At operation 750, a second responder may be determined to be associated with the first responder or the issue. The association may be determined based on skills of the first and the second responders matching attributes of the issue. The UI component may be provided to the second responder to enable additional interactions with the target device at operation 760. In addition, a second communication may be detected between the second responder and the first responder or the target device associated with the issue at operation 770. And, the first communication and the second communication may be integrated into a communication session associated with the issue at operation 780.

At operation 790, a history of the session may be recorded and formatted into a timeline list. The timeline list may include interactions sorted based on a start time of the interaction and/or the duration of the interactions. The interactions may include communications between the responders and the target device. The interactions may also include transcript of the communications. The interactions may also be sorted based on health status of the target device after execution of each interaction. Next, the history may be provided in a subsequent issue having common attributes with the issue at operation 795. The similarity of the attributes may be determined based on matching attributes including support technician, responder, target device, applications, issue description, and similar ones.

The operations included in process 700 are for illustration purposes. A UC client application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for integrating support actions with client communications, the method comprising:
receiving an escalation of a support issue from a support technician;
associating the issue with a first responder;
initiating a first communication between the first responder and a target device associated with the issue;
providing a user interface (UI) component to the first responder wherein the UI component is associated with the first communication to enable interactions with the target device;
determining a second responder associated with at least one of: the first responder and the issue; and
providing the UI component to the second responder to enable additional interactions with the target device.

2. The method of claim 1, further comprising:
detecting a second communication between the second responder and at least one of: the first responder and the target device associated with the issue;
integrating the first communication and second communication into a communication session associated with the issue;
recording a history of the communication session formatted into a timeline list; and
providing the history in a subsequent issue having common attributes with the issue.

3. The method of claim 1, further comprising:
associating the escalation with the issue based on a contextual information associated with a third communication from the support technician including a description of the issue and an escalation status.

4. The method of claim 1, further comprising:
establishing an instant messaging (IM) communication with the target device; and
transmitting a command that is inputted on a command prompt to the target device to execute an operation associated with the command at the target device.

5. The method of claim 4, further comprising:
receiving a response from the target device describing a result of the executed operation; and
formatting the response to display in a response prompt.

6. The method of claim 4, further comprising:
retrieving potential commands associated with a portion of the command from a historical data store managing prior commands associated with other communications based on the portion matching the prior commands; and
suggesting the potential commands for transmission to the target device to execute other operations associated with the potential commands.

7. The method of claim 1, further comprising:
establishing a remote control session (RCS) with the target device.

8. The method of claim 7, further comprising:
mirroring another UI component associated with an application on the target device.

9. The method of claim 8, further comprising:
limiting access to the mirrored UI component based on privileges of an account associated with the RCS;
selecting credentials of the account from one of: the first responder, the second responder, the support technician, and a support account; and
transmitting the credentials to the target device to initiate the RCS.

10. The method of claim 7, further comprising:
displaying an event viewer showing events associated with applications of the target device.

11. The method of claim 1, further comprising:
determining a third responder associated with at least one of: the first responder, the second responder, and the issue;
detecting a fourth communication associated with the issue between the third responder and at least one of the first responder, the second responder, and the target device; and
integrating the fourth communication into the communication session.

12. A computing device for integrating support actions with client communications, the computing device comprising:
a memory;
a processor coupled to the memory, the processor executing a unified communications (UC) client application in conjunction with instructions stored in the memory, wherein the UC client application is configured to:
receive an escalation of a support issue from a support technician through a first communication from the support technician associating the escalation with the issue based on a contextual information associated with the first communication including a description of the issue and an escalation status;
associate the issue with a first responder;
initiate a second communication between the first responder and a target device associated with the issue;
provide a user interface (UI) component to the first responder wherein the UI component is associated with the second communication to enable interactions with the target device;
determine a second responder associated with at least one of: the first responder and the issue;
provide the UI component to the second responder to enable additional interactions with the target device;
detect a third communication between the second responder and at least one of: the first responder and the target device associated with the issue; and
integrate the first communication, the second communication, and the third communication into a communication session associated with the issue.

13. The computing device of claim 12, wherein the UC client application is further configured to:
record a history of the session formatted into a timeline list;
provide the history in a subsequent issue having common attributes with the issue; and
index the history based on a contextual information associated with at least one of: the target device, the issue, the support technician, the first responder, the second responder, a type of one of the interactions associated with the issue, a description of the interaction, and a result of the interaction.

14. The computing device of claim 12, wherein the UC client application is further configured to:
include at least one of the interactions from: a recording of a call with the support technician, a transcript of the call, and at least one interaction summary associated with a remote control session (RCS) within the history.

15. The computing device of claim 14, wherein the UC client application is further configured to:
sort the history into the timeline list based on at least one of: a start time and a duration of the at least one of the interactions;
transmit the history to a third responder to display the history in another device associated with the third responder; and
add the third responder to at least one of: the first communication, the second communication, and the third communication.

16. The computing device of claim 15, wherein the UC client application is further configured to:
include actionable items associated with the at least one the interactions to re-execute operations associated with the at least one of the interactions in another target device to diagnose and fix the other target device.

17. A computer-readable memory device with instructions stored thereon for integrating support with client communications, the instructions comprising:
receiving an escalation of an at least one support issue from a support technician through a first communication from the support technician associating the escalation with the at least one issue based on a contextual information associated with the communication including a description of the at least one issue and an escalation status;
associating the at least one issue with a first responder;
initiating a second communication including one of: an instant messaging (IM) session, an audio call, a video call, and a remote control session (RCS) with an at least one target device associated with the at least one issue;
providing a user interface (UI) component associated with the second communication to enable interactions with the at least one target device;
determining a second responder associated with at least one of: the first responder and the at least one issue;
providing the UI component to the second responder to enable additional interactions with the at least one target device;
detecting a third communication between the second responder and at least one of: the first responder and the at least one target device associated with the at least one issue;
integrating the first communication, the second communication, and the third communication into a communication session associated with the at least one issue;
recording a history of the session formatted into a timeline list; and
providing the history in a subsequent issue having common attributes with the at least one issue.

18. The computer-readable memory device of claim 17, wherein the instructions further comprise:
contacting other devices and applications associated with the first responder and the second responder to notify the first responder and the second responder of the escalation.

19. The computer-readable memory device of claim 17, wherein the instructions further comprise:
recording a health status of the at least one issue in association with the interactions of the at least one issue recorded in the history to capture a changing health status of the at least one target device during the interactions with the at least one target device.

20. The computer-readable memory device of claim 17, wherein the instructions further comprise:
using the timeline list of the history to create a postmortem report of the at least one issue; and
transmitting the postmortem report to at least one of: the first responder, the second responder, the support technician, a third party, and another application.
